(19) United States
(12) Patent Application Publication
(10) Pub. No.: US 2016/0128067 A1
(43) Pub. Date: May 5, 2016

(54) SYSTEMS AND METHODS FOR TRANSMITTING A POSITIONING SIGNAL USING MULTIPLE CARRIER CHANNELS

(71) Applicant: NextNav, LLC, Sunnyvale, CA (US)

(72) Inventor: Cristina Seibert, Mountain View, CA (US)

(21) Appl. No.: 14/883,858

(22) Filed: Oct. 15, 2015

Related U.S. Application Data
(60) Provisional application No. 62/075,246, filed on Nov. 5, 2014.

(51) Int. Cl. H04W 72/04; G01S 19/29; G01S 19/35; G01S 19/30

(52) U.S. Cl. CPC H04W 72/0453; G01S 19/30; G01S 19/29; G01S 19/35

(57) ABSTRACT

Transmitting positioning signals from transmitters in a positioning system. In certain implementations, one or more positioning signals are generated at a transmitter and transmitted using two or more carrier channels at the same time. In one implementation, only one positioning signal is generated and transmitted on each of the two or more carrier channels at the same time. In another implementation, two or more positioning signals are generated, and each of those positioning signals is transmitted on a different carrier channel at the same time.

### FIELD

Various embodiments relate to wireless communications, and more particularly, to methods, systems, means and machine-readable media for transmitting positioning signals from transmitters in a positioning system using two or more carrier channels.

### BACKGROUND

Quickly and accurately estimating locations of things (e.g., people, vehicles, business assets) in a geographic area can be used to speed up emergency response times, track movement, and link consumers to nearby businesses. Most approaches rely on a process called trilateration, which uses geometry to estimate the position of each thing using distances traveled by different positioning signals (also referred to as “ranging” signals) that are transmitted from three or more transmitters to receivers that are co-located with those things.

Various networks of transmitters, such as orbiting satellites in the Global Positioning Satellite (GPS) system, have been used to transmit positioning signals (also referred to as “navigation” signals). In GPS, each satellite transmits a positioning signal using a coarse/acquisition (C/A) code or other code, and the positioning signal is eventually received by a receiver. After receiving the positioning signal, the receiver identifies the time that positioning signal was transmitted by the satellite, and also the time the positioning signal was received. Once the transmission time and the reception time of the positioning signal are known, then the receiver uses the difference between those times multiplied by speed of light to compute a range measurement (also referred to as a “pseudorange” measurement) that estimates the distance traveled by that positioning signal. With range measurements from three or more satellites, the receiver can determine its position using trilateration.

Unfortunately, GPS signals are very faint, which means that it takes a very long time for a receiver to find a GPS signal and acquire enough information to determine range measurements. In many cases, the accuracy of the range measurements lacks desired levels of accuracy due to delays in finding the direct path of the GPS signal and acquiring enough information to compute an estimated range measurement associated with the direct path of the GPS signal.

In urban environments, problems with weak GPS signals are more prominent, since those weak GPS signals often cannot reach receivers through buildings, or the GPS signals take on multiple paths after reflecting off of buildings, which disrupts a receiver's ability to accurately estimate a range measurement between the receiver and the satellite. Thus, terrestrial transmitter systems are typically necessary for urban environments, since such terrestrial transmitter systems provide stronger signals and also include transmitters at different locations in the urban environment in order to reduce the number of circumstances when positioning signals are obstructed by buildings or when positioning signals take on multiple paths.

Examples of terrestrial transmitter systems that transmit positioning signals are described in U.S. Pat. No. 8,130,141 (the '141 patent), which is currently owned by the assignee of this disclosure. In at least one embodiment of the '141 patent, each terrestrial transmitter uses a GPS-like channel to transmit a precisely-timed positioning signal. The receiver computes its location by processing the positioning signals from three or more terrestrial transmitters in a similar way to how it would process GPS positioning signals from three or more GPS satellites. Since most (if not all) receivers understand how to process GPS signaling, the terrestrial transmitter system can be adopted by most (if not all) receivers with minimal to no modifications to those receivers.

Even though the terrestrial transmitter systems described in the '141 patent provide a more-reliable positioning service than GPS, certain issues inherent in GPS signal processing cannot be eliminated since some embodiments of these terrestrial transmitter systems use terrestrial positioning signals that are processed by a receiver in a similar way that the receiver processes GPS positioning signals (e.g., similar or same chipping rates and codes are used). Clearly, systems and methods that can increase the accuracy of ranging measurements for such terrestrial transmitter systems would further enhance what is already a highly-effective terrestrial transmitter system for estimating positions of receivers.

### SUMMARY

Various embodiments, but not necessarily all embodiments, described in this disclosure relate generally to methods, systems (e.g., networks, devices or components), means, and machine-readable media for transmitting positioning signals from transmitters in a positioning system. Such embodiments may generate one or more positioning signals using a transmitter, and transmit the one or more positioning signals using two or more carrier channels at the same time. In certain embodiments, only one positioning signal is generated and transmitted on each of the carrier channels at the same time from the transmitter. In another embodiment, at least two positioning signals are generated, and each of those positioning signals is transmitted on a different carrier channel at the same time from the transmitter. The details of one or more embodiments of the invention are set forth in the accompanying drawings and the description below.

### BRIEF DESCRIPTION OF THE DRAWINGS

FIG. 1 depicts aspects of a positioning system.

FIG. 2 depicts aspects of a signal generation system.

FIG. 3A illustrates an approach for allocating carrier channels that are used to transmit different instances of the same position signal from a transmitter at the same time.

FIG. 3B illustrates an approach for allocating carrier channels that are used to transmit different position signals from a transmitter at the same time.

FIG. 4A illustrates another approach for allocating carrier channels that are used to transmit different instances of the same position signal from a transmitter.

FIG. 4B illustrates another approach for allocating carrier channels that are used to transmit different position signals from a transmitter.

FIG. 5A illustrates an approach for allocating carrier channels that are used to transmit different instances of the same position signal from a transmitter based on orthogonal frequency-division multiplexing.

FIG. 5B illustrates an approach for allocating carrier channels that are used to transmit different position signals from a transmitter based on orthogonal frequency-division multiplexing.

FIG. 6A and FIG. 6B illustrate a receiver's ability to isolate three paths of a positioning signal when different instances of the same position signal or different positioning signals are transmitted from a transmitter on one and two carrier channels.

FIG. 7A and FIG. 7B illustrate a receiver's ability to isolate four paths of a positioning signal when different instances of the same position signal or different positioning signals are transmitted from a transmitter on two and three carrier channels.

FIG. 8A and FIG. 8B illustrate a receiver's ability to isolate five paths of a positioning signal when different instances of the same position signal or different positioning signals are transmitted from a transmitter on three and four carrier channels.

Like reference numbers and designations in the drawings indicate like elements.

### DETAILED DESCRIPTION

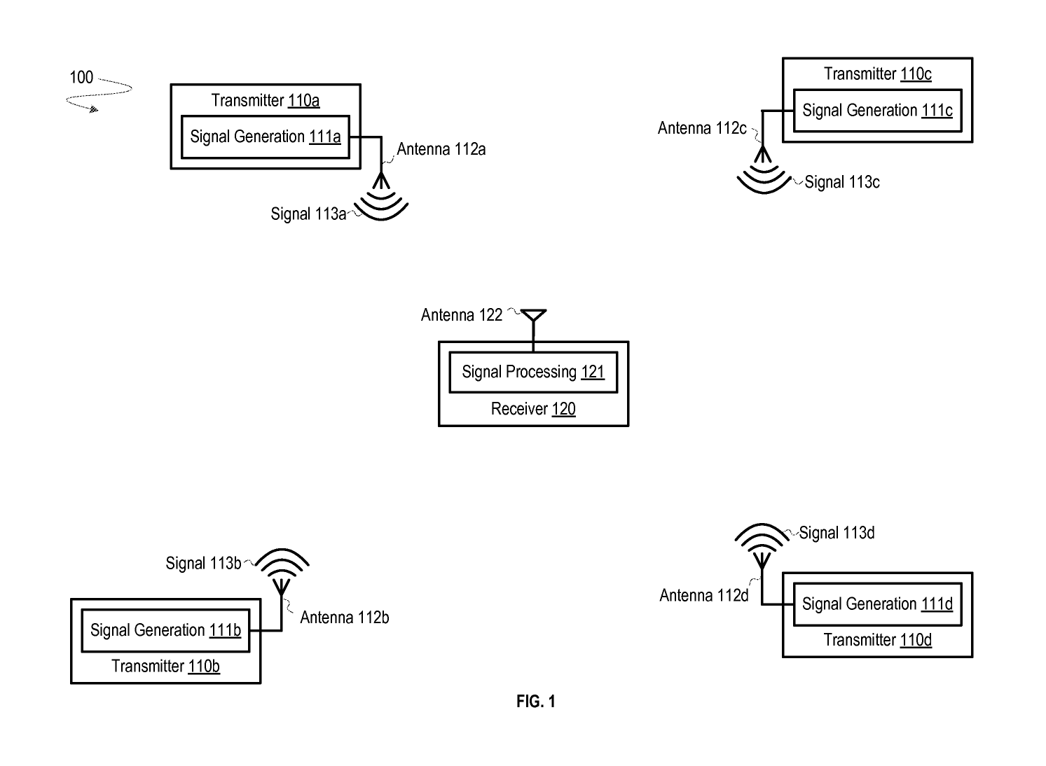

This disclosure relates to terrestrial transmitter systems that generate positioning signals, and transmit those positioning signals to receivers so the positions of those receivers can be estimated. By way of example, FIG. 1 depicts a system 100 with terrestrial transmitters 110 and a receiver 120.

As shown in FIG. 1, each of the transmitters 110a-d includes a signal generation component 111a-d for generating positioning signals and other signals, and one or more antennas 112a-d for transmitting the generated signals. By way of example, generation of signals by each of the transmitters 110a-d may be carried out using analog/digital logic and power circuitry, signal processing circuitry, tuning circuitry, buffer and power amplifiers, and/or other components known by one of ordinary skill in the art. Each of the transmitters 110a-d generates and transmits a positioning signal 113a-d that is received by an antenna 122 of the receiver 120. The positioning signal 113a-d is then processed by a signal processing component 121 of the receiver 120. By way of example, the signal processing by the receiver 120 may be carried out using A/D converters, digital signal processors and/or other components known in the art.

In one embodiment, the positioning signals 113a-d are generated so that conventional GPS signal processing hardware of the receiver 120 need not be modified to support both GPS positioning signals from GPS satellites (not shown) and the positioning signals 113a-d from the terrestrial transmitters 110. For example, such positioning signals 113a-d may be generated using pseudo-random sequences like Gold codes with good cross-correlation properties.

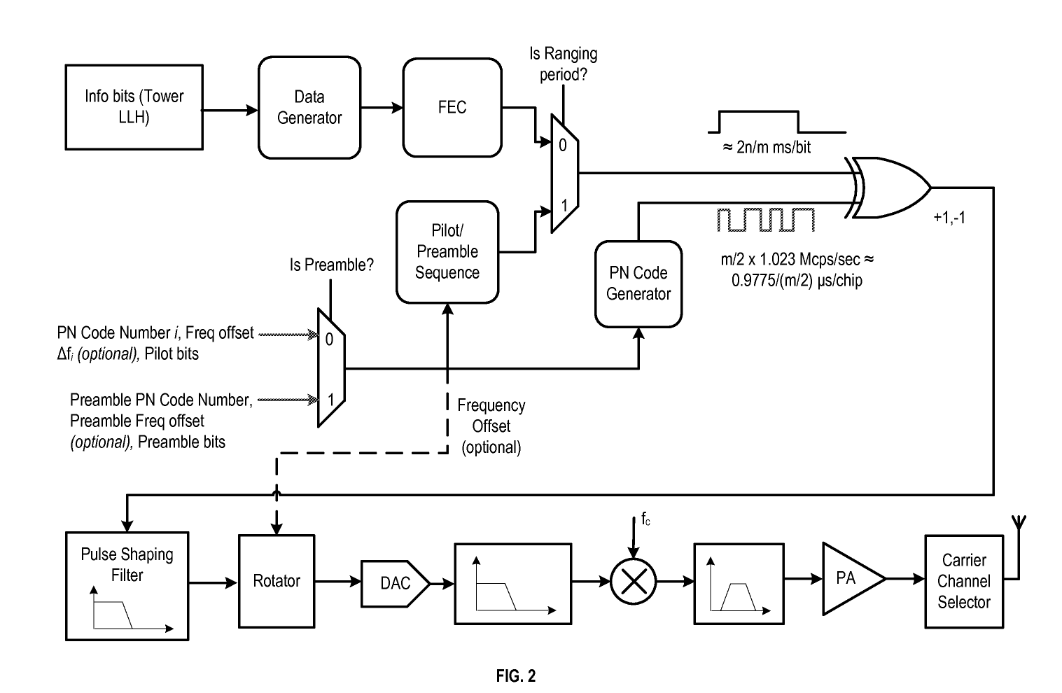

By way of example, FIG. 2 depicts a signal generation system with a sequence/PN code generator that generates binary waveforms of length (1024 n)−1, and generates chips at a rate of m/2*1.023 Mchips/sec where m is an integer (e.g., greater than or equal to 2), which are similar to those generated in GPS systems. FIG. 2 further depicts a data generator that collects information and formats the information into frames, and a pilot/preamble sequence generator for generating preamble bits that help with signal acquisition and pilot bits that enable long coherent integration to improve ranging performance.

FIG. 2 also depicts an optional carrier channel selector that selects the number of carrier channels on which a positioning signal or multiple positioning signals are transmitted during a time period (e.g., transmitted simultaneously, sequentially, in another format). The selection of the number of carrier channels is described in more detail below. It is noted that selection of sub-carrier channels can be substituted for selection of carrier channels in any embodiment relating to selecting carrier channels. In some embodiments, the selector includes any suitable hardware as would be understood in the art for making the selection. In one particular embodiment, the selector is a processor that executes instructions that are stored in memory, where the instructions designate how the selection is made.

### Transmitting the Same Positioning Signal or Different Positioning Signals on Multiple Carrier Channels

The systems in FIG. 1 and FIG. 2 permit each of the transmitters 110 to transmit a positioning signal 113 to the receiver 120, which processes the positioning signal 113 using processing techniques that are known in the art (e.g., techniques used to process a positioning signal from a GPS satellite or a terrestrial transmitter). However, as described in further detail below, each of the transmitters 110 can transmit multiple instances of the same positioning signal, or can transmit different positioning signals, at the same time by dividing a total available frequency bandwidth into frequency sub-bands that form different carrier channels, and then carrying each instance of the positioning signal or each of the different positioning signals on a different carrier channel. Each carrier channel can be spaced far enough apart in frequency to avoid overlap of sub-band frequencies. By way of example, if the total bandwidth is 8 MHz, and 2 MHz sub-bands are desired for each carrier channel, then a total of four carrier channels are possible.

On the receiver side, the receiver 120 tunes to each of the carrier channels, and then processes the positioning signals received from each carrier channel to achieve greater signal diversity and bandwidth. Doing so results in a more-accurate range measurement for the particular transmitter that transmitted the multiple instances of the same positioning signal or the different positioning signals that is not possible from processing only one instance of one positioning signal. For example, by monitoring more carrier channels, a receiver can more-accurately identify direct and multipath propagation paths of signals, which permits the receiver to improve its estimate of direct path signal propagation time, and hence improve its estimate of the range between the receiver 120 and the transmitter 110. It may also be possible to mitigate fading by monitoring more carrier channels.

A multi-carrier channel approach for delivery of the multiple instances of the same positioning signal or the different positioning signals to the receiver 120 differs from a typical frequency-division multiplexing (FDM) approach at least because each carrier channel carries a positioning signal from the same transmitter instead of carrying a different positioning signal from a different transmitter as is done in typical FDM approaches. Given that bandwidth is considered to be a precious resource in transmitter networks, occupying several carrier channels with multiple instances of the same positioning signal or with different positioning signals from the same transmitter would naturally be avoided because each instance of that positioning signal or the multiple positioning signals would be viewed as redundant and, therefore, an undesirable use of bandwidth that could otherwise be allocated to other signals. Also, transmitting the same positioning signal or multiple positioning signals from a single transmitter using multiple carrier channels compels a receiver to search for more signals, which impacts processing capabilities of the receiver and consumes more power. However, the advantages of transmitting the same positioning signal or multiple positioning signals from the same transmitter on multiple carrier channels to achieve more accurate range measurements outweigh the cost associated with bandwidth use and processing.

As will be further explored below, management of bandwidth resources is possible such that a positioning signal or different positioning signals can be transmitted on each of N carrier channels that are dynamically selected from among 1 or more available carrier channels, where N can be modified over time to account for load requirements, regulatory restrictions, and need of certain accuracy levels. Additionally, receivers can selectively monitor any number of the N carrier channels depending localized conditions at the receiver, including available processing resources, limitations on the number of carrier channels that the receiver can monitor, desired accuracy and/or other conditions.

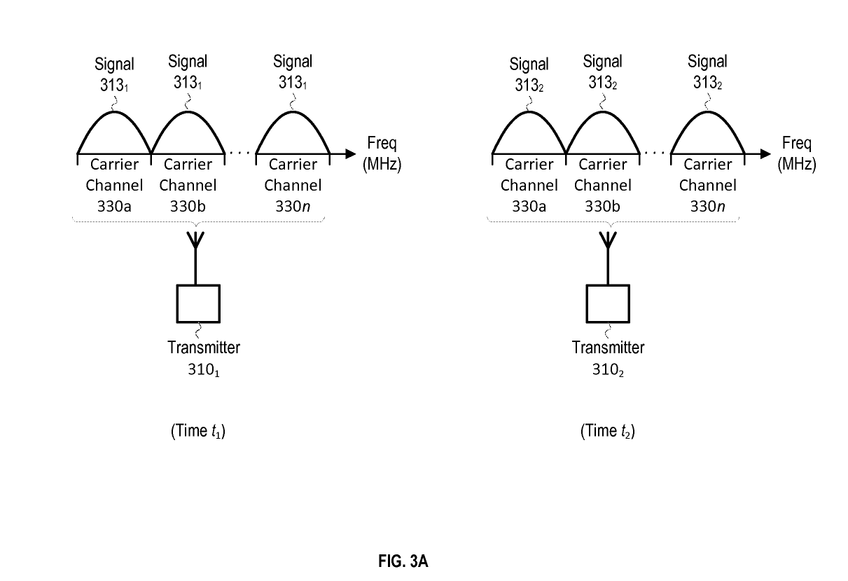

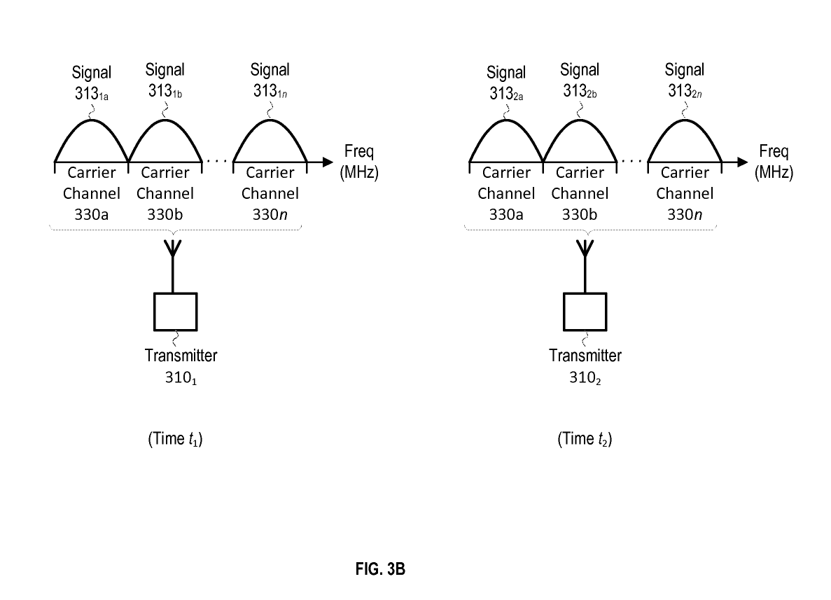

By way of example, FIG. 3A depicts an approach for allocating carrier channels 330a-n to each instance of a first positioning signal 313₁ from a first transmitter 310₁ during a first transmission time period t₁, and allocating the same carrier channels 330a-n to each instance of a second positioning signal 313₂ from a second transmitter 310₂ during a second transmission time period t₂. Allocation of the same carrier channels 330a-n continues for other positioning signals from other transmitters during other transmission periods until a receiver (not shown) receives enough positioning signals to estimate its position using trilateration.

Although not shown, the receiver may use positioning signals received on all of the carrier channels 330a-n, a subset of positioning signals received from a corresponding subset of the carrier channels 330a-n (e.g., carrier channels 330a and 330b only, even where other carrier channels 330c-n are used to carry the positioning signal), or positioning signals received from only one carrier channel (e.g., carrier channel 330a, but not carrier channels 330b-n). In this way, different capabilities of different receivers can be exploited without excluding receivers that cannot process signals from multiple carrier channels. This approach is valuable where some receivers are legacy receivers that cannot process certain bandwidths, while other receivers can process those bandwidths.

FIG. 3B, by comparison, depicts an approach for allocating carrier channels 330a-n to different positioning signals 313₁ₐ₋ₙ from a first transmitter 310₁ during a first transmission time period t₁, and allocating the same carrier channels 330a-n to different positioning signals 313₂ₐ₋ₙ from a second transmitter 310₂ during a second transmission time period t₂.

### Receivers that Select the Number of Carrier Channels to Monitor

It is noted that transmission of the same positioning signal or different positioning signals using multiple carrier channels enables individual receivers to determine how many instances of the positioning signal to process instead of having the transmitter make that decision. Each receiver can dynamically monitor varying numbers of the carrier channels over time depending on different conditions.

For example, the number of carrier channels being monitored can depend on a desired level of accuracy, where the receiver monitors all carrier channels for a high level of accuracy (e.g., 2 meters from true position), fewer carrier channels for a mid-range level of accuracy (e.g., 10 meters from true position), and one carrier channel for a low level of accuracy (e.g., 100 meters from true position).

Different approaches may be taken to determine how many carrier channels are monitored by a receiver. For example, a subscription service can control how many carrier channels a receiver can monitor—e.g., where a first receiver that is subscribed to a first service can monitor a first number of the carrier channels to achieve a first level of accuracy, a second receiver that is subscribed to a second service can monitor a second number of the carrier channels to achieve a second level of accuracy, and a third receiver that is not subscribed to a service can monitor only one of the carrier channels to achieve the lowest level of accuracy. Permissions for each service that define the number of channels that can be monitored may be stored in a data source of the receiver. An application running on the receiver may be used to control how many channels can be monitored as would be understood in the art.

A receiver can also scale how many carrier channels it monitors (and how many corresponding instances of a positioning signal it processes) based on processing or power constraints for that receiver. For example, a receiver with one amount of available processing/power capability may monitor fewer carrier channels than another receiver with a greater amount of available processing/power capability. Thus, resources at each receiver can be identified, and then use of those resources can be managed.

Of course, the number of available carrier channels with the same positioning signal or different positioning signals may vary as well, as described below.

### Transmitters that Select the Number of Carrier Channels to Use

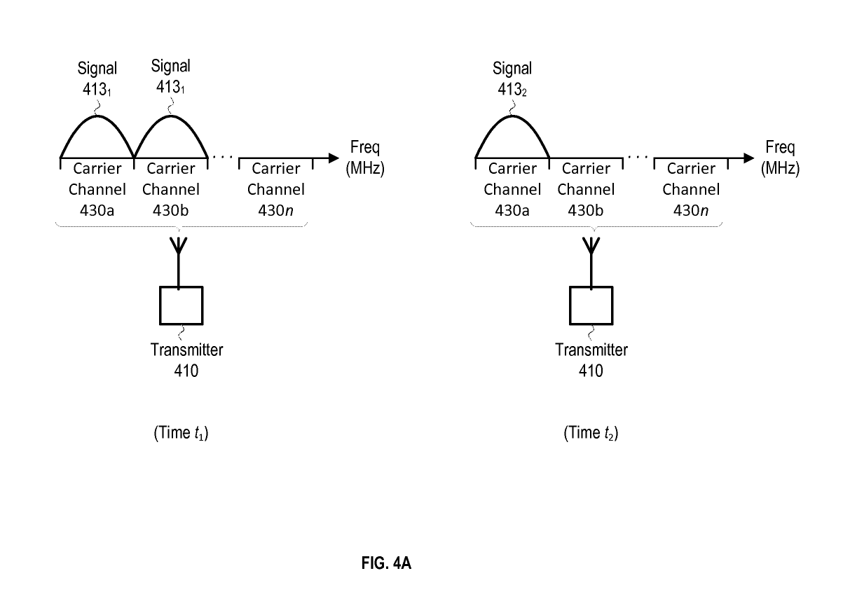

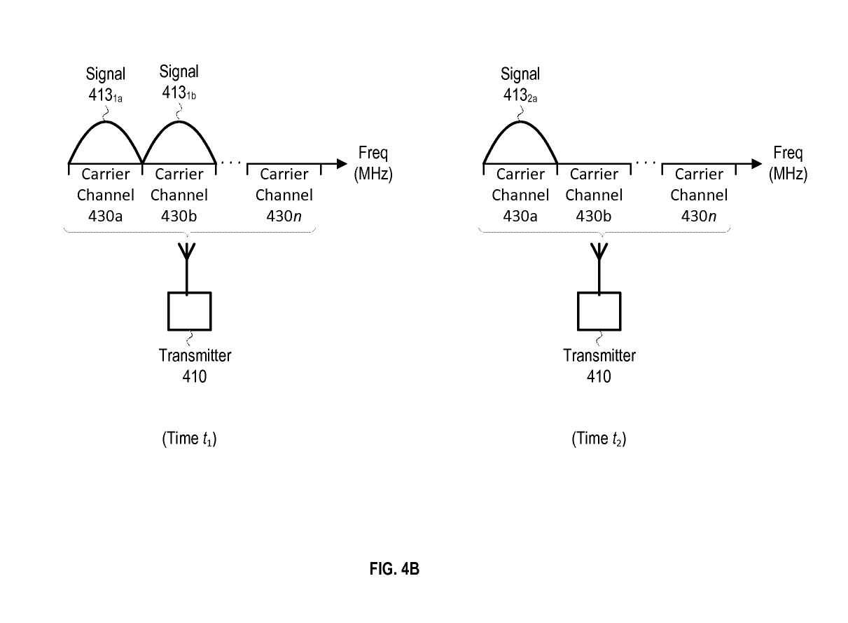

In some embodiments, the terrestrial transmitter system selectively allocates different numbers of carrier channels for each positioning signal at different times. By way of example, FIG. 4A depicts different times, t₁ and t₂, when the same transmitter 410 transmits positioning signals 413₁ and 413₂ using different numbers of carrier channels 430a-n. At t₁, the transmitter 410 transmits positioning signal 413₁ using the carrier channels 430a and 430b. At t₂, the transmitter 410 transmits positioning signal 413₂ using only the carrier channel 430a. In the example of FIG. 4A, the two transmitters 410₁ and 410₂ select two and one carrier channel(s), respectively. Of course, alternative numbers of carrier channels can be selected by each transmitter, and the two transmitters can select the same or different channels. FIG. 4B, by comparison, depicts different times, t₁ and t₂, when the same transmitter 410 transmits a different positioning signal 413₁ₐ, 413_{1b} or 413₂ₐ using different numbers of carrier channels 430a-n.

Different approaches may be taken to determine how many carrier channels to use. In one embodiment, a computing component (e.g., a processor) in communication with the transmitter 410 may first determine available bandwidth, and may then use a number of carrier channels that are permitted by the available bandwidth—e.g., if the total bandwidth is B Hz, and b Hz is allocated for each carrier channel, then the maximum number N of carrier channels is N=B/b.

In another embodiment, an average amount of allowed bandwidth usage over a time period is determined along with an average amount of actual bandwidth usage during that time period, and a number of carrier channels are selected to maintain the average amount of actual bandwidth usage over the time period at or below the average amount of allowed bandwidth usage. For example, if regulatory restrictions dictate that an average of 3 MHz can be used over two transmission periods, and each carrier channel uses 2 MHz, then one carrier channel is used during one transmission period and two carrier channels are used during the other transmission period, or no carrier channels are used during one transmission period and three carrier channels are used during the other transmission period. Any combination of using different numbers of carrier channels during any number of transmission periods is possible so long as the average use across those transmission periods is at or below the average amount of allowed bandwidth usage.

Selecting a number of carrier channels to use can also be on a transmitter-by-transmitter basis instead of on a transmission period basis. For example, each transmitter may be surveyed for multipath effect on its positioning signals, and it may be determined that positioning signals from certain transmitters are less affected by multipath than positioning signals from other transmitters. Once this information is known, the number of carrier channels allocated for a positioning signal from a transmitter that is more affected by multipath may be greater than the number of carrier channels allocated for a positioning signal from another transmitter that is less affected by multipath.

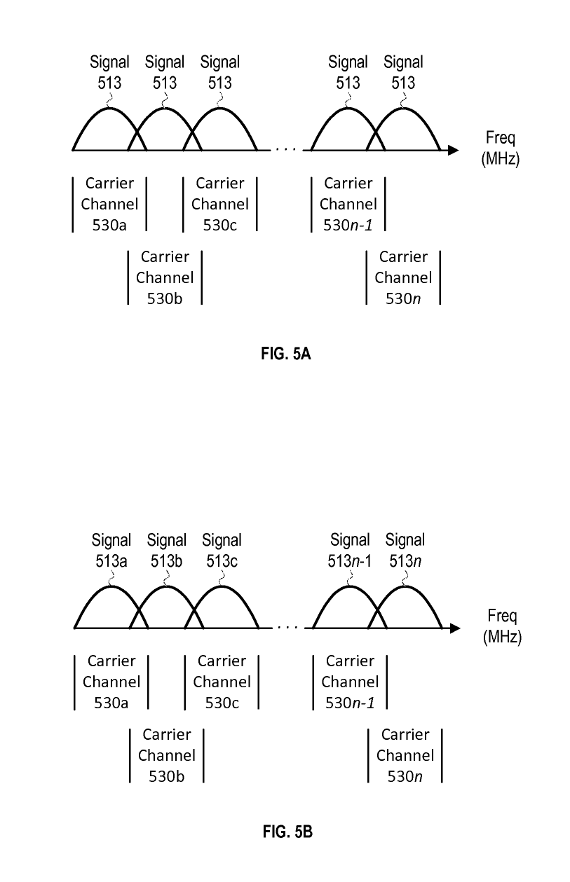

It is noted that FIG. 3A through FIG. 4B depict a simple frequency-division multiplexing (FDM) approach for allocating carrier channels; however, other approaches are contemplated, including orthogonal frequency-division multiplexing (OFDM) approaches. In other embodiments, an OFDM approach is used where neighboring carrier channels overlap each other in frequency to maximize spectral efficiency, but the carrier channels are orthogonal to each other to avoid interfering with each other. By way of example, FIG. 5A illustrates an approach for allocating carrier channels that are used to transmit different instances of the same position signal from a transmitter based on orthogonal frequency-division multiplexing. FIG. 5B, by comparison, illustrates an approach for allocating carrier channels that are used to transmit different position signals 513a-n from a transmitter based on orthogonal frequency-division multiplexing.

### Resolving Multipath Using Multiple Carrier Channels

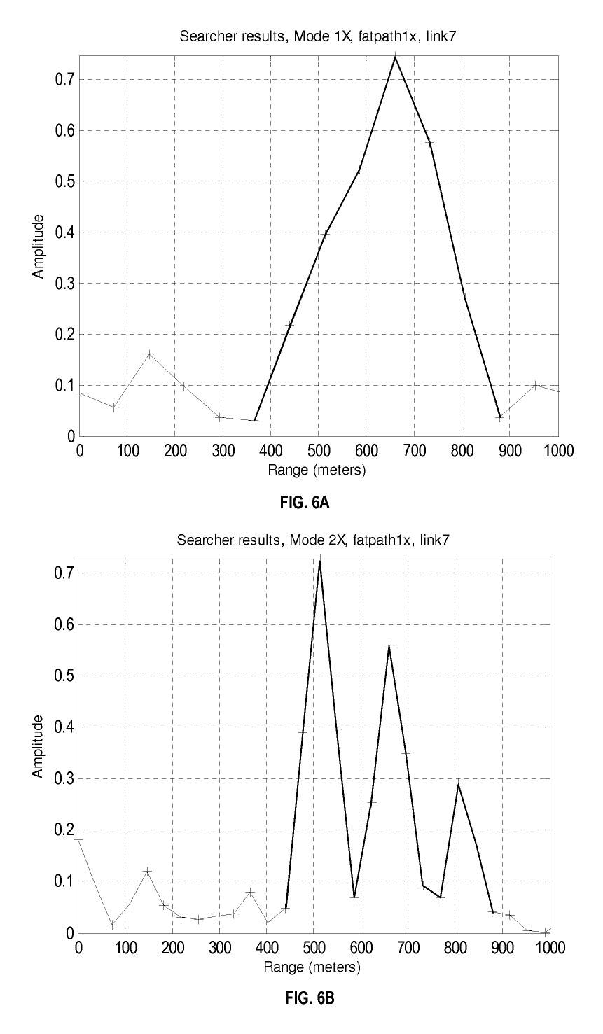

The use of multiple narrow-band carrier channels to transmit the same positioning signal or different positioning signals from a transmitter improves a receiver's ability to process multipath conditions in the environment. To illustrate this, FIG. 6A through FIG. 8B each depict simulations of a receiver's ability to isolate a different number of signal paths by monitoring different numbers of carrier channels. Each of FIG. 6A through FIG. 8B show the receiver's performance in relation to two of the following modes: (1) monitoring one carrier channel; (2) monitoring two carrier channels; (3) monitoring three carrier channels; and (4) monitoring four carrier channels.

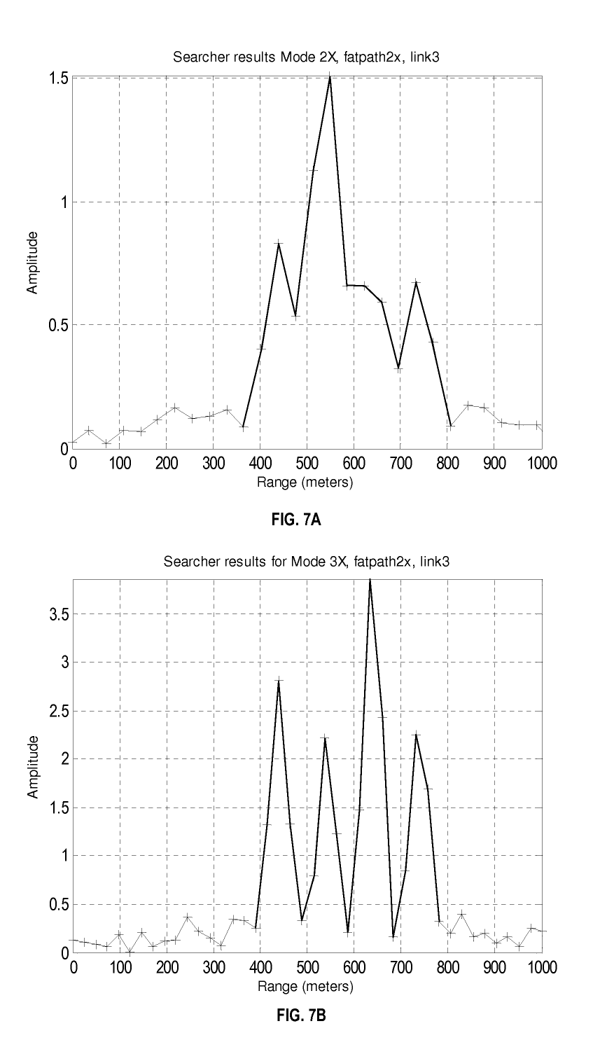

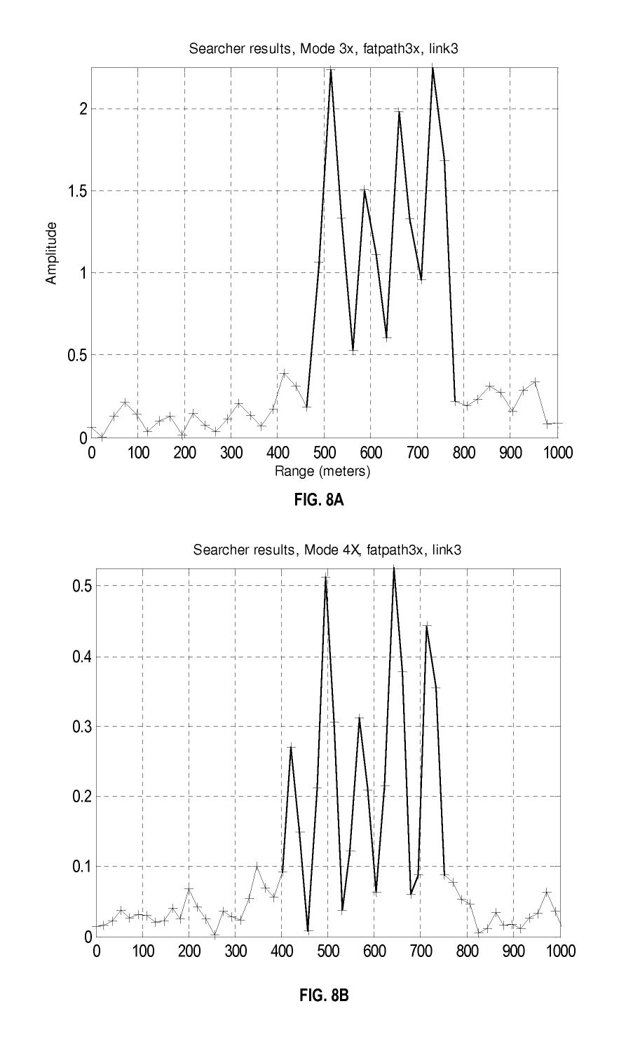

FIG. 6A and FIG. 6B illustrate a receiver's ability to isolate three paths of a positioning signal (each separated by 500 ns) when different instances of the same position signal or different positioning signals are transmitted from a transmitter on one and two carrier channels. FIG. 7A and FIG. 7B illustrate a receiver's ability to isolate four paths of a positioning signal (each separated by 333 to 334 ns) when different instances of the same position signal or different positioning signals are transmitted from a transmitter on two and three carrier channels. FIG. 8A and FIG. 8B illustrate a receiver's ability to isolate five paths of a positioning signal (each separated by 250 ns) when different instances of the same position signal or different positioning signals are transmitted from a transmitter on three and four carrier channels.

As shown in FIG. 6A, the receiver cannot isolate each of the three signal paths when only one carrier channel is used, which results in a single “fat” path that consists of the three paths that cannot be isolated; however, as FIG. 6B shows, the receiver can isolate each signal path when at least two carrier channels are used. As shown in FIG. 7A, the receiver cannot isolate each of the four signal paths when only one or two carrier channels are used; however, as FIG. 7B shows, the receiver can isolate each signal path when at least three carrier channels are used. As shown in FIG. 8A, the receiver cannot isolate each of the five signal paths when only one, two or three carrier channels are used; however, as FIG. 8B shows, the receiver can isolate each signal path when at least four carrier channels are used.

FIG. 6A through FIG. 8B each illustrate that using more carrier channels increases the likelihood that a receiver will identify different signal paths of positioning signals transmitted by a transmitter, which allows the receiver to estimate an improved measurement of range between the receiver and the transmitter. It follows that knowledge of multipath characteristics of a terrestrial transmitter system can be used to select an appropriate number of carrier channels to use at each transmitter. For example, multipath characteristics can be surveyed before the decision to use a particular number of carrier channels is made. Alternatively, the existence of multiple signal paths can be assumed when it is determined that a receiver cannot isolate different signal paths of a positioning signal or when the estimated range measurement exceeds a maximum possible range in the system, after which a transmitter transmits a positioning signal on more carrier channels to increase the likelihood that the receiver can discern between each path that positioning signal takes to the receiver.

### Additional Considerations and Design Choices

The approaches described above can be used to create multiple instances of any positioning signal, or to create different positioning signals, including signals that are modeled after the GPS C/A signal, the GPS Precision signal, any type of positioning signal defined by a standards body, or any other type of positioning signal.

The approaches described above can be used to separate a signal into two or more parts, and then transmit each part using two or more carrier channels (e.g., part 1 on channels 1 and 2 at time 1, and part 2 on channels 1 and 2 at time 2; e.g., part 1 on channels 1 and 2 at time 1, and part 2 on channels 3 and 4 at time 1).

As previously noted, sub-carrier channels may be used instead of carrier channels. It is noted that a channel may be of any size; however, as previously illustrated in this disclosure, the size of each channel in some embodiments is a narrow frequency band of 2 MHz or less. Of course, the size of a channel may be based on the size of pre-defined frequency bands like ISM bands and others. The size of a channel may alternatively be based on bandwidths that are supported by particular phones in order to provide positioning signals that are compatible with most (if not all) phones.

Various carrier frequencies are contemplated. For example, a first carrier frequency of 921.723 MHz is used in one embodiment (where 921.723 MHz=90*10.23+1.023 MHz), and additional carrier frequencies include 923.769 MHz (923.769 MHz=921.723 MHz+2*1.023 MHz), 925.815 MHz (925.815 MHz=923.769 MHz+2*1.023 MHz), and so on. In some embodiments, carrier frequencies are multiples of 10.23 MHz, which is a fundamental frequency in GPS—e.g., L1=1575.42 MHz (where 1575.42 MHz=154×10.23) and L2=1227.60 MHz (where 1227.60 MHz=120×10.23). Chipping rates of 1.023 MHz and/or 10.23 MHz may also be used.

Different orthogonal channels (e.g., quadrature phase and in phase) may also be used to transmit the same positioning signal or different positioning signals or different positioning signals in addition to or instead of transmitting the same positioning signal or different positioning signals or different positioning signals on multiple carrier channels.

The same or different spreading codes can be used for each carrier channel. Use of different codes could lead to more accuracy by improving cross-correlation associated with the different spreading codes.

Transmitting the same positioning signal or different positioning signals on different channels can offer certain advantages, including minimization of processing time, and compatibility with GPS signaling protocols. However, different positioning signals can be transmitted on different channels from the same transmitter. This could result in different ranging codes being used for different carrier channels. When using the same positioning signal or different positioning signals, GNSS (e.g., GPS) processing circuitry of the receiver can be used to process those signals. For example the receiver can process each individual carrier as it would a single GPS carrier, process multiples of those carriers, and/or process all of the received streams by means of integer scaling of GNSS processing capabilities (e.g., by running the clock at multiples of the initial clocking speed; e.g. overclocking), and doing so while using exiting despreading logic and circuitry.

The same transmission period can be allocated to a transmitter over time, or different transmission periods can be allocated to that transmitter over time. Also, the length of the transmission period can vary over time.

Different combinations of the above aspects are possible, including (1) use of different types of positioning signals, (2) use of different carrier channel sizes, (3) use of different carrier frequencies, (4) use of orthogonal channels, (5) use of the same or different spreading codes, (6) use of the same or different positioning signals, and/or (7) use of the same or different transmission periods with the same or different lengths.

In various embodiments, including at least one embodiment that uses an OFDM approach for transmitting a positioning signal, a transmitter uses a technique such as an inverse fast Fourier transform (IFFT) to convert from code samples allocated to frequency domain carriers into a stream of time samples that is sent over the air. A receiver with a-priori knowledge of this transmitter configuration generates an identical multi-carrier signal and correlates (e.g., pattern matching) against the received waveform in order to identify the time-of-arrival of that signal.

### Additional Aspects

Functionality and operation disclosed herein may be embodied as one or more methods implemented, in whole or in part, by machine(s)—e.g., processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more processors cause the processors to carry out the method(s).

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time.

By way of example, not by way of limitation, method(s) and processor(s) or other means may: generate one or more positioning signals; and transmit the one or more positioning signals from a first transmitter using each carrier channel in a first set of two or more carrier channels at a first time.

In one embodiment, the one or more positioning signals consist of a first positioning signal that is transmitted from the first transmitter on each of the carrier channels in the first set of two or more carrier channels at the first time.

Method(s) and processor(s) or other means may further or alternatively: generate a second positioning signal; and transmit the second positioning signal from a second transmitter using each carrier channel in the first set of carrier channels at a second time.

Method(s) and processor(s) or other means may further or alternatively: generate a second positioning signal; and transmit the second positioning signal from a first transmitter using each carrier channel in a second set of carrier channels at a second time.

In one embodiment, the first transmitter is a terrestrial transmitter, and the first positioning signal is generated such that it can be processed using a GPS chipset after it is transmitted. Such GPS chipsets include typical GPS chipsets used in mobile phones and in other mobile devices.

Method(s) and processor(s) or other means may further or alternatively: select the first set of carrier channels from a plurality of carrier channels. In one embodiment, the first set of carrier channels is selected based on an amount of available bandwidth and a size of each of the plurality of carrier channels.

Method(s) and processor(s) or other means may further or alternatively: select the first set of carrier channels based on a first amount of available bandwidth that is available at the first time; and select the second set of carrier channels based on a second amount of available bandwidth that is available at the second time.

In one embodiment, the carrier channels are orthogonal to each other.

Method(s) and processor(s) or other means may further or alternatively: use a first spreading code to transmit the first positioning signal on each of carrier channels in the first set of carrier channels.

Method(s) and processor(s) or other means may further or alternatively: use a first spreading code to transmit the first positioning signal on a first carrier channel in the first set of carrier channels at the first time; and use a second spreading code to transmit the first positioning signal on a second carrier channel in the first set of carrier channels at the first time.

In one embodiment, the one or more positioning signals consist of at least two different positioning signals, each of which is transmitted from the first transmitter on a different one of the two or more carrier channels at the first time.

By way of example, not by way of limitation, one or more apparatuses may comprise hardware modules that perform the methods or particular steps of the methods disclosed herein. In one embodiment, a transmitter includes: a generation module to generate one or more positioning signals, wherein the generation module includes one or more outputs to send the one or more positioning signals; and a transmission module with one or more inputs to receive the one or more positioning signals, and with channel outputs to transmit the one or more positioning signals to one or more receivers.

In one embodiment, the positioning signal(s) consist of one positioning signal.

In another embodiment, the one or more positioning signals include two different positioning signals, and the channel outputs include one channel output to transmit one of the different positioning signals and another channel output to transmit another of the different positioning signals.

The transmitter may further or alternatively include: a selection module to make a determination as to how many of the channel outputs to use when transmitting the one or more positioning signals, wherein the selection module includes an output to send the determination.

In one embodiment, the selection module determines how many of the channel outputs to use based on an amount of available bandwidth and a size of available carrier channels available for transmitting the positioning signal. In one embodiment, the selection module determines how many of the channel outputs to use based on an amount of available bandwidth that is available during a predefined time period.

In one embodiment, the transmission module includes an input that receives the determination.

In one embodiment, the transmitter is a terrestrial transmitter and the generation module generates the positioning signal such that it can be processed using a GPS chipset of a receiver after it is transmitted from the transmitter.

### Examples of Other Features in Some Embodiments

A “receiver” may take the form of a computing device (e.g., mobile phone, tablet, PDA, laptop, camera, tracking tag). A receiver may also take the form of any component of the computer, including a processor. Processing by the receiver can also occur at a server.

The illustrative methods described herein may be implemented, performed, or otherwise controlled by suitable hardware known or later-developed by one of skill in the art, or by firmware or software executed by processor(s), or any combination of hardware, software and firmware. Software may be downloadable and non-downloadable at a particular system. Such software, once loaded on a machine, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement any or all of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

All of the information disclosed herein may be represented by data, and that data may be transmitted over any communication pathway using any protocol, stored on data source(s), and processed by a processor. Transmission of data may be carried out using a variety of wires, cables, radio signals and infrared light beams, and an even greater variety of connectors, plugs and protocols even if not shown or explicitly described. Systems may exchange information with each other using any communication technology. Data, instructions, commands, information, signals, bits, symbols, and chips and the like may be represented by voltages, currents, electromagnetic waves, magnetic fields or particles, or optical fields or particles.

Features in system figures that are illustrated as rectangles may refer to hardware, firmware or software. It is noted that lines linking two such features may be illustrative of data transfer between those features. Such transfer may occur directly between those features or through intermediate features. Where no line connects two features, transfer of data between those features is contemplated unless otherwise stated.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

It is noted that the term “GPS” may refer to any Global Navigation Satellite Systems (GNSS), such as GLONASS, Galileo, and Compass/Beidou, and vice versa.

### Related Applications

This application relates to U.S. Patent Application Ser. No. 62/075,246, filed Nov. 5, 2014, entitled SYSTEMS AND METHODS FOR TRANSMITTING A POSITIONING SIGNAL USING MULTIPLE CARRIER CHANNEL, the content of which is hereby incorporated by reference herein in its entirety.

1. A method for transmitting positioning signals from transmitters in a positioning system, the method comprising:
generating one or more positioning signals; and
transmitting the one or more positioning signals from a first transmitter using each carrier channel in a first set of two or more carrier channels at a first time.

2. The method of claim 1, wherein the one or more positioning signals consist of a first positioning signal that is transmitted from the first transmitter on each of the carrier channels in the first set of two or more carrier channels at the first time.

3. The method of claim 2, wherein the method further comprises:
generating a second positioning signal; and
transmitting the second positioning signal from a second transmitter on each carrier channel in the first set of carrier channels at a second time.

4. The method of claim 2, wherein the method further comprises:
generating a second positioning signal; and
transmitting the second positioning signal from the first transmitter on each carrier channel in a second set of carrier channels at a second time.

5. The method of claim 2, wherein the first transmitter is a terrestrial transmitter, and wherein the first positioning signal is generated such that it can be processed using a GPS chipset after it is transmitted.

6. The method of claim 2, wherein the method further comprises:
selecting the first set of carrier channels from a plurality of carrier channels.

7. The method of claim 6, wherein the first set of carrier channels is selected based on an amount of available bandwidth and a size of each of the plurality of carrier channels.

8. The method of claim 4, wherein the method further comprises:
selecting the first set of carrier channels based on a first amount of available bandwidth that is available at the first time; and
selecting the second set of carrier channels based on a second amount of available bandwidth that is available at the second time, wherein the first and second amounts are different.

9. The method of claim 2, wherein the two or more carrier channels are orthogonal to each other.

10. The method of claim 2, wherein the method further comprises:
using a first spreading code to transmit the first positioning signal on each of carrier channels in the first set of carrier channels.

11. The method of claim 2, wherein the method further comprises:
using a first spreading code to transmit the first positioning signal on a first carrier channel in the first set of carrier channels; and
using a second spreading code to transmit the first positioning signal on a second carrier channel in the first set of carrier channels.

12. The method of claim 1, wherein the one or more positioning signals consist of at least two different positioning signals, each of which is transmitted from the first transmitter on a different one of the two or more carrier channels at the first time.

13. A non-transitory machine-readable medium embodying program instructions adapted to be executed to implement a method for transmitting positioning signals from transmitters in a positioning system, the method comprising:
generating one or more positioning signals; and
transmitting the one or more positioning signals from a first transmitter using each carrier channel in a first set of two or more carrier channels at a first time.

14. A system for transmitting positioning signals, wherein the system comprises a transmitter that includes:
a generation module to generate one or more positioning signals, wherein the generation module includes one or more outputs to send the one or more positioning signals; and
a transmission module with one or more inputs to receive the one or more positioning signals, and with channel outputs to transmit the one or more positioning signals to one or more receivers.

15. The system of claim 14, wherein the one or more positioning signals consist of one positioning signal.

16. The system of claim 14, wherein the one or more positioning signals include two different positioning signals, and the channel outputs include one channel output to transmit one of the different positioning signals and another channel output to transmit another of the different positioning signals.

17. The system of claim 14, wherein the system further includes:
a selection module to make a determination as to how many of the channel outputs to use when transmitting the one or more positioning signals, wherein the selection module includes an output to send the determination.

18. The system of claim 17, wherein the selection module determines how many of the channel outputs to use based on an amount of available bandwidth and a size of available carrier channels available for transmitting the positioning signal.

19. The system of claim 17, wherein the selection module determines how many of the channel outputs to use based on an amount of available bandwidth that is available during a predefined time period.

20. The system of claim 14, wherein the transmitter is a terrestrial transmitter and the generation module generates the one or more positioning signals such that the one or more positioning signals can be processed using a GPS chipset of a receiver after the one or more positioning signals are transmitted from the transmitter.
